(19) United States
(12) Patent Application Publication
(10) Pub. No.: US 2018/0348510 A1
(43) Pub. Date: Dec. 6, 2018

(54) OPTICAL FILM, OPTICAL ELEMENT, AND OPTICAL SYSTEM

(71) Applicant: FUJIFILM Corporation, Tokyo (JP)

(72) Inventor: Hideki YASUDA, Ashigarakami-gun (JP)

(73) Assignee: FUJIFILM Corporation, Tokyo (JP)

(21) Appl. No.: 16/041,500

(22) Filed: Jul. 20, 2018

Related U.S. Application Data
(63) Continuation of application No. PCT/JP2016/087203, filed on Dec. 14, 2016.

(30) Foreign Application Priority Data
Mar. 11, 2016 (JP) 2016-048924

(51) Int. Cl. G02B 27/00; G02B 1/115; B32B 15/04

(52) U.S. Cl. CPC G02B 27/0018; B32B 15/04; G02B 1/115

(57) ABSTRACT

Provided are an optical film which has a reflectivity of 0.50% or less with respect to all wavelengths of 400 nm, 550 nm, and 700 nm, a visible light transmittance that is higher than that of a transparent base material, and excellent rub resistance, an optical element, and an optical system. An optical film includes a transparent base material, a dielectric layer, a metal layer having an interface with the dielectric layer and containing at least silver, and an interlayer positioned between the metal layer and the transparent base material, in which a film thickness of the metal layer is less than 5.0 nm and the metal layer has a refractive index of 0.40 or less with respect to a wavelength of 550 nm.

### CROSS-REFERENCE TO RELATED APPLICATIONS

This application is a Continuation of PCT International Application No. PCT/JP2016/087203 filed on Dec. 14, 2016, which claims priority under 35 U.S.C § 119(a) to Japanese Patent Application No. 2016-048924 filed on Mar. 11, 2016. Each of the above application(s) is hereby expressly incorporated by reference, in its entirety, into the present application.

### BACKGROUND OF THE INVENTION

### 1. Field of the Invention

The present invention relates to an optical film, an optical element, and an optical system.

### 2. Description of the Related Art

Conventionally, in a transparent base material using a light transmitting member of glass, plastic, or the like (for example, a lens), for the purpose of reducing the loss of transmitted light due to surface reflection of the transparent base material and suppressing the occurrence of a ghost due to surface reflection of the transparent base material, an antireflection film is provided on a light incident surface. The ghost refers to a phenomenon that another image shifted from a correct image is generated by re-reflection of light, which is reflected at the rear surface of a lens, from the lens surface.

As an antireflection film exhibiting a very low reflectivity with respect to visible light, a fine unevenness structure having a pitch shorter than a wavelength in a visible light range and a configuration including a layer formed by using a sol-gel method as the outermost layer have been known (refer to JP2012-159720A, JP2005-316386A, and the like).

JP2012-159720A discloses that a low reflectivity is obtained in a wide wavelength range of a visible light range by using an antireflection film having a fine unevenness structure having an average pitch of 400 nm or less on the outermost layer as a layer of low refractive index.

JP2005-316386A discloses that a low reflectivity is obtained in a wide wavelength range of a visible light range by using an antireflection film having a layer formed by using a sol-gel method on the outermost layer as a layer of low refractive index. In addition, the layer formed by using a sol-gel method in JP2005-316386A is a layer in which secondary particles are deposited by aggregating several primary particles in which about several to 10 atoms or molecules are aggregated and has a refractive index of 1.3 or less.

On the other hand, an antireflection film including a metal layer containing silver (Ag) in a laminate of dielectric layers is proposed as an antireflection film not provided with a structural layer such as a fine unevenness structure or a layer formed by using a sol-gel method on the surface (refer to JP2013-238709A and JP4560889B).

JP2013-238709A discloses an optical laminate which includes a dielectric layer having a surface exposed to air, a metal layer having an interface with the dielectric layer and containing at least Ag, and a laminate having an interface with the metal layer and including at least one or more layers of low refractive index and one or more layers of high refractive index, and has a reflectivity of 0.1% or less in a wavelength range of 460 nm or more and 650 nm or less.

In addition, JP4560889B proposes an antireflection film which is formed by laminating a transparent film having a film thickness of 12 nm to 55 nm and a refractive index of 1.8 to 2.5, a film having a film thickness of 4.7 nm to 9.2 nm and containing silver, and a transparent film having a film thickness of 55 nm to 100 nm and a refractive index of 1.3 to 1.6 on a base material in this order from the base material side, and has a film surface reflectivity of 0.6% or less with respect to an incidence ray at a wavelength of 550 nm.

### SUMMARY OF THE INVENTION

The outermost surfaces (the first lens surface and the last lens rear surface) of a group lens used in an optical system such as a camera lens can be touched by a user. Therefore, it is required for an antireflection film for a lens at the outermost surface side of a group lens to have high mechanical strength, particularly, rub resistance against an external force such as wiping.

A structural layer such as a fine unevenness structure or a layer formed using a sol-gel method formed on the surface of each of the antireflection films disclosed in JP2012-159720A and JP2005-316386A has a fine structure. Therefore, the antireflection films disclosed in JP2012-159720A and JP2005-316386A have a low mechanical strength, are very weak to an external force such as wiping, and have poor rub resistance.

In addition, since light in a wide wavelength range of a visible light range of 400 nm to 700 nm is incident into the optical system such as a camera lens, it is desired that the antireflection film also has performance satisfying a reflectivity of 0.50% or less in a wide wavelength range of a visible light range. Therefore, it is required to reduce the reflectivity at 550 nm close to the center of the visible light range and also reduce the reflectivity even at 400 nm on the short wavelength side and at 700 nm on the long wavelength side of the visible light range.

According to graphs showing simulation results, antireflection films described in test examples of JP2013-238709A have a reflectivity of more than 0.50% at a wavelength of 400 nm. In addition, according to a graph showing visible light reflectivity, an antireflection film described in an example of JP4560889B has a reflectivity of more than 0.50% at a wavelength of 400 nm. Therefore, the antireflection films disclosed in JP2013-238709A and JP4560889B have a narrow wavelength range width in which the reflectivity is small in the visible light range.

Further, in the optical system such as a camera lens, it is required for an antireflection film to have a visible light transmittance higher than that of a transparent base material (such as a lens).

The visible light transmittance of the antireflection film described in the example of JP4560889B is about 87.7% and the visible light transmittance of the antireflection film is lower than the visible light transmittance of soda lime glass used as a transparent base material.

An object of the present invention is to provide an optical film having a reflectivity of 0.50% or less with respect to all wavelengths of 400 nm, 550 nm, and 700 nm, a visible light transmittance that is higher than that of the transparent base material, and excellent rub resistance.

Another object of the present invention is to provide an optical element and an optical system having an optical film.

As a result of conducting intensive investigation under such circumstances, the present inventors have found that an optical film formed by laminating a transparent base material, an interlayer, a metal layer containing a silver and having a refractive index of 0.40 or less and a film thickness of less than 5.0 nm, and a dielectric layer in this order has a reflectivity of 0.50% or less with respect to all wavelengths of 400 nm, 550 nm, and 700 nm, a visible light transmittance that is higher than that of the transparent base material, and excellent rub resistance. That is, the present inventors have found that the objects can be achieved by using the optical film having the above configuration and thus have completed the present invention.

The present invention and preferable configurations of the present invention are as follows.

[1] An optical film comprising:

a transparent base material;

a dielectric layer;

a metal layer having an interface with the dielectric layer and containing at least silver; and

an interlayer positioned between the metal layer and the transparent base material,

in which a film thickness of the metal layer is less than 5.0 nm, and

the metal layer has a refractive index of 0.40 or less with respect to a wavelength of 550 nm.

[2] The optical film according to [1], further comprising:

an anchor layer formed of a metal other than silver between the metal layer and the interlayer.

[3] The optical film according to [2],

in which the anchor layer is formed of germanium, titanium, chromium, niobium, or molybdenum.

[4] The optical film according to [2] or [3],

in which a film thickness of the anchor layer is 0.2 nm to 2 nm.

[5] The optical film according to any one of [1] to [4],

in which the metal layer is a silver alloy containing at least one kind of metal atoms other than silver.

[6] The optical film according to any one of [1] to [5] having a reflectivity of 0.50% or less with respect to all wavelengths of 400 nm, 550 nm, and 700 nm.

[7] The optical film according to any one of [1] to [6] having a visible light transmittance higher than a visible light transmittance of the transparent base material.

[8] An optical element comprising:

the optical film according to any one of [1] to [7].

[9] An optical system comprising:

a group lens including a plurality of lenses,

in which a lens at an outermost surface of the group lens has the optical film according to any one of [1] to [7].

According to the present invention, it is possible to provide an optical film having a reflectivity of 0.50% or less with respect to all wavelengths of 400 nm, 550 nm, and 700 nm, a visible light transmittance that is higher than that of the transparent base material, and excellent rub resistance.

According to the present invention, it is also possible to provide an optical element and an optical system having an optical film.

### BRIEF DESCRIPTION OF THE DRAWINGS

FIG. 1 is a schematic view showing a cross section of an example of an optical film of the present invention.

FIG. 2 is a graph of the spectral reflectivity of an optical film in Example 5.

FIG. 3 is a graph showing a relationship between visible light transmittance and refractive index of a metal layer.

FIG. 4 is a graph showing a relationship between reflectivity and film thickness of a metal layer.

FIG. 5 is an image of a metal layer used in the optical film in Example 5 obtained with a transmission electron microscope (TEM).

FIGS. 6A, 6B and 6C are schematic view showing an example of a configuration of an optical system of the present invention.

FIG. 7 is a schematic view showing a cross section of the other example of an optical film of the present invention.

### DESCRIPTION OF THE PREFERRED EMBODIMENTS

Hereinafter, the contents of the present invention will be described in detail.

The description of the constitutional requirements described below is made based on representative embodiments of the present invention, but it should not be construed that the present invention is limited to those embodiments.

In the present specification, numerical value ranges expressed by the term “to” mean that the numerical values described before and after “to” are included as a lower limit and an upper limit, respectively.

[Optical Film]

An optical film of the present invention is an optical film having

a transparent base material,

a dielectric layer,

a metal layer having an interface with the dielectric layer and containing at least silver, and

an interlayer positioned between the metal layer and the transparent base material,

in which a film thickness of the metal layer is less than 5.0 nm, and

the metal layer has a refractive index of 0.40 or less with respect to a wavelength of 550 nm.

By adopting the above configuration, the optical film of the present invention has a reflectivity of 0.50% or less with respect to all wavelengths of 400 nm, 550 nm, and 700 nm, a visible light transmittance that is higher than that of the transparent base material, and excellent rub resistance.

First, since the film thickness of the metal layer containing silver in the optical film of the present invention is optimally designed, it is possible to obtain an antireflection effect in a wide range. Specifically, the optical film of the present invention has a reflectivity of 0.50% or less with respect to all wavelengths of 400 nm, 550 nm, and 700 nm, and an antireflection effect is obtained in a wide wavelength range. Here, the antireflection film disclosed in JP2013-238709A is provided to obtain an antireflection effect in a wavelength range of 460 nm or more and 650 nm or less. A sufficient antireflection effect is obtained in a wavelength range of 460 nm or more and 650 nm or less in a case where the film thickness of the metal layer containing silver is 5.0 nm or more. However, according to the investigations conducted by the present inventors, it has been found that it is not possible to obtain a reflectivity of 0.50% or less with respect to all wavelengths of 400 nm, 550 nm, and 700 nm, in a case where the film thickness of the metal layer containing silver is 5.0 nm or more. In contrast, in the present invention, it is possible to obtain a reflectivity of 0.50% or less with respect to all wavelengths of 400 nm, 550 nm, and 700 nm by using a metal layer containing silver and having a film thickness of less than 5.0 nm and an interlayer.

Second, since the refractive index of the metal layer in the optical film of the present invention is 0.40 or less, the visible light transmittance can be made higher than that of the transparent base material. The refractive index in the present invention indicates a refractive index real part (also referred to as a real part) in a case of expression in a complex refractive index.

Typically, it is considered that there is a high correlation between the visible light transmittance and the refractive index imaginary part (also referred to as an imaginary part), also called an extinction coefficient, of a substance and there is a low correlation between the visible light transmittance and the refractive index of a substance.

The present inventors have investigated the relationship between the refractive index of the metal layer and the visible light transmittance of the optical film including the metal layer in a case where the film thickness of the metal layer is less than 5.0 nm.

As a result, remarkably, it has been found that there is a high correlation between the refractive index and the visible light transmittance and in a case where the refractive index of the metal layer is 0.40 or less, the visible light transmittance of the optical film is higher than that of the transparent base material.

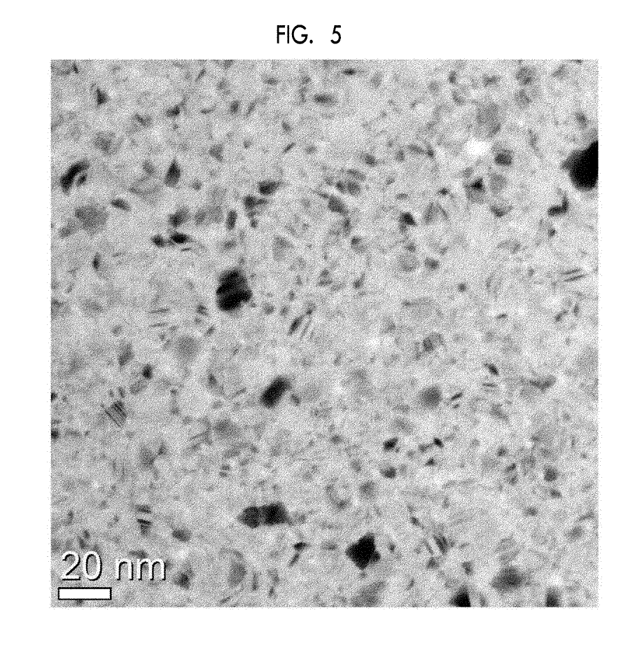

Third, the optical film of the present invention has excellent rub resistance. In the optical film of the present invention, as shown in a TEM image in FIG. 5, the metal layer is present in the form of a polycrystalline film and thus unevenness is present on the surface of the metal layer or voids are present in the metal layer in some cases. However, in order to set the film thickness of the metal layer containing silver to less than 5.0 nm, the unevenness on the surface of the metal layer is basically small. In addition, the optical film further has a dielectric layer on the metal layer. Therefore, even in a case where an external force is applied to the surface of the optical film of the present invention (the surface on the dielectric layer side), the effect of the external force to the metal layer can be reduced. As a result, even in a case where an external force is applied to the surface of the optical film (the surface on the dielectric layer side), the optical film of the present invention has reflectivity which hardly increases and excellent rub resistance. The optical film of the present invention having excellent rub resistance can be applied to a surface of an optical element or an optical system which is touched by the hand of a user.

Further, it is preferable that the optical film of the present invention has almost no variation in refractive index caused by a fine unevenness structure on the surface thereof. Here, in the antireflection film provided with a fine unevenness structure disclosed in JP2012-159720A or the like, there is a variation in refractive index caused by the fine unevenness structure and thus there is a concern of light scattering occurring due to the variation in refractive index. On the other hand, in the optical film of the present invention, as shown in the TEM image in FIG. 5, the metal layer is present in the form of a polycrystalline film and unevenness is present on the surface of the metal layer or voids are present in the metal layer in some cases. However, in order to set the film thickness of the metal layer containing silver to less than 5.0 nm, the unevenness on the surface of the metal layer is basically small. In addition, the optical film further has a dielectric layer on the metal layer. Therefore, a variation in refractive index caused by the structure of the surface of the optical film of the present invention (the surface on the dielectric layer side) can be made smaller than a variation in refractive index caused by the fine unevenness structure disclosed in JP2012-159720A or the like. As a result, the optical film of the present invention can be formed as an optical film in which light scattering hardly occurs. In a case where the antireflection film in a camera lens can suppress light scattering, the occurrence of flare can be suppressed and deterioration in contrast of an image captured by a camera can be suppressed. That is, it is greatly advantageous to form the optical film of the present invention as an optical film in which light scattering hardly occurs.

Hereinafter, preferable aspects of the optical film of the present invention will be described in detail.

<Properties>

(Reflectivity)

The optical film of the present invention has a reflectivity of 0.50% or less with respect to all wavelengths of 400 nm, 550 nm, and 700 nm. The optical film of the present invention is preferably an antireflection film.

Light of which reflection is to be prevented by the optical film of the present invention varies depending on the purpose. The wavelength of light of which reflection is to be prevented (reflection prevention target light) by the optical film of the present invention is light with wavelengths of at least 400 nm, 550 nm, and 700 nm and is preferably light in the entire visible light range. As necessary, reflection of light in an infrared region and an ultraviolet light range may be further prevented.

The optical film of the present invention preferably has a reflectivity of 0.40% or less more preferably has a reflectivity of 0.30% or less, and particularly preferably has a reflectivity of 0.20% or less with respect to all wavelengths of 400 nm, 550 nm, and 700 nm.

(Visible Light Transmittance)

The visible light transmittance of the optical film of the present invention is higher than that of the transparent base material. The visible light transmittance of the transparent base material varies depending on the purpose. According to the visible light transmittance of the transparent base material to be used, the visible light transmittance of the optical film of the present invention can be adjusted to be higher than the visible light transmittance of the transparent base material.

A difference between the visible light transmittance of the optical film and the visible light transmittance of the transparent base material is not particularly limited and can be set to, for example, 0.50% or more.

The visible light transmittance of the optical film of the present invention is preferably more than 84.0%, more preferably more than 87.0%, particularly preferably more than 88.0%, and more particularly preferably more than 92.0%.

<Configuration>

The optical film of the present invention has a transparent base material, a dielectric layer, a metal layer having an interface with the dielectric layer, and an interlayer positioned between the metal layer and the transparent base material.

FIG. 1 is a schematic view showing a cross section of an example of an optical film 1 of the present invention. As shown in FIG. 1, the optical film 1 of the present invention has a transparent base material 2, a dielectric layer 5, a metal layer 4 having an interface with the dielectric layer 5, and an interlayer 3 positioned between the metal layer 4 and the transparent base material 2. That is, the optical film 1 of the present invention preferably has the interlayer 3, the metal layer 4, and the dielectric layer 5 on the transparent base material 2 in this order.

The transparent base material 2 and the interlayer 3 may be in direct contact with each other or another layer may be provided between the transparent base material 2 and the interlayer 3. It is preferable that the transparent base material 2 and the interlayer 3 are in direct contact with each other.

The interlayer 3 may be a single layer or a laminate of two or more layers.

The interlayer 3 and the metal layer 4 may be in direct contact with each other or another layer may be provided between the interlayer 3 and the metal layer 4. It is preferable that the interlayer 3 and the metal layer 4 are in direct contact with each other.

The metal layer 4 has an interface with the dielectric layer 5. That is, the metal layer 4 is in direct contact with at least a part of the dielectric layer 5. It is preferable that the entire surface of the metal layer 4 is in direct contact with the dielectric layer 5.

The dielectric layer 5 preferably has a surface exposed to the outside of the optical film 1. That is, it is preferable that the optical film 1 of the present invention has the dielectric layer 5 as the outermost layer. However, the dielectric layer 5 may not be the outermost layer and a layer having a film thickness which does not affect optical properties may be present on the surface of the dielectric layer 5 on the opposite side of the metal layer 4. The layer having a film thickness which does not affect optical properties refers to a layer having a film thickness 1/50 times or less a wavelength λ of reflection prevention target light. The layer having a film thickness which does not affect optical properties is preferably a layer having a film thickness 1/100 times or less a wavelength λ of reflection prevention target light. As an example of the layer having a film thickness which does not affect optical properties, for example, an antifouling layer having a film thickness of 1 nm may be mentioned. An optical film 1 of an aspect in which the layer having a film thickness which does not affect optical properties is present on the outside of the dielectric layer 5 is also included in the present invention.

The outside of the optical film 1 may be air or vacuum. For example, the outside of the optical film 1 may be another medium such as a gas having a nitrogen content higher than the nitrogen content in air. It is preferable that the outside of the optical film 1 is air.

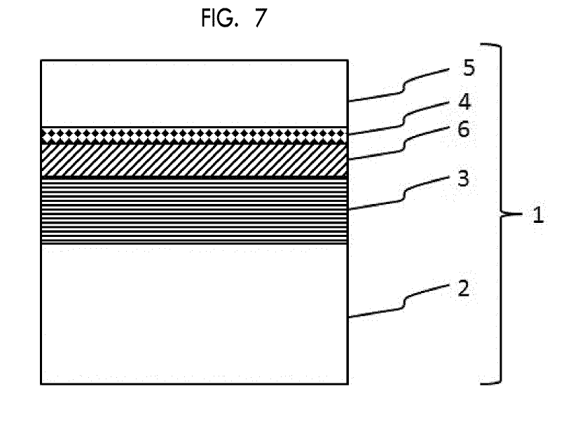

The optical film 1 of the present invention preferably has an anchor layer 6 shown in FIG. 7 formed of a metal other than silver between the metal layer 4 and the interlayer 3.

<Transparent Base Material>

The optical film of the present invention has a transparent base material.

The shape of the transparent base material 2 is not particularly limited and a transparent base material that is mainly used in an optical device such as a flat plate, a concave lens, or a convex lens can be used. In addition, the transparent base material 2 may be constituted by a combination of a curved surface having a positive or negative curvature and a flat surface. As the material for the transparent base material 2, glass, plastic, and the like can be used.

Here, the term “transparent” means that the visible light transmittance is 80% or more.

The refractive index of the transparent base material 2 is preferably 1.45 or more, more preferably 1.61 or more, particularly preferably 1.74 or more, and more particularly preferably 1.84 or more. The transparent base material 2 may be, for example, a high power lens such a first lens of a group lens of a camera.

The visible light transmittance of the transparent base material is not particularly limited as long as the transparent base material is transparent. The visible light transmittance of the transparent base material is, for example, 84.0% to 92.0%.

Specific examples of the transparent base material include S-NBH5 (manufactured by Ohara Inc.), quartz (quartz glass), S-LAL18 (manufactured by Ohara Inc.), and FDS90 (manufactured by HOYA Corporation).

Other specific examples of the transparent base material include transparent base materials of plastics such as acrylic resin and polycarbonate resin.

<Interlayer>

The optical film of the present invention has an interlayer positioned between the metal layer and the transparent base material.

The interlayer is preferably an interlayer constituted of a single layer having a refractive index different from the refractive index of the transparent base material or an interlayer having a structure in which a layer of high refractive index and a layer of low refractive index are alternately laminated.

In a case where the interlayer is an interlayer constituted of a single layer having a refractive index different from the refractive index of the transparent base material, the refractive index of the interlayer is higher than the refractive index of the transparent base material and an antireflection effect is exhibited in a wide wavelength range. Therefore, this case is preferable.

In the case where the interlayer is an interlayer constituted of a single layer having a refractive index different from the refractive index of the transparent base material transparent, it is preferable to use silicon nitride, titanium oxide, and zinc oxide for the interlayer since the refractive index of the interlayer can be made sufficiently higher than the refractive index of the base material and the antireflection effect can be enhanced.

It is preferable that the interlayer is an interlayer having a structure in which a layer of high refractive index and a layer of low refractive index are alternately laminated. Specific examples of a case of an interlayer having a structure in which a layer of high refractive index and a layer of low refractive index are alternately laminated will be described.

It is preferable that the interlayer is an interlayer in which a layer of high refractive index and a layer of low refractive index are alternately laminated. A layer of low refractive index and a layer of high refractive index may be laminated from the transparent base material side in order or a layer of high refractive index and a layer of low refractive index may be laminated from the transparent base material side in order. In addition, the interlayer preferably includes 4 or more layers and preferably includes 16 or less layers from the viewpoint of suppressing costs.

The layer of high refractive index may be a layer having a refractive index higher than the refractive index of the layer of low refractive index, and the layer of low refractive index may be a layer having a refractive index lower than the refractive index of the layer of high refractive index. It is more preferable that the refractive index of the layer of high refractive index is higher than the refractive index of the transparent base material and the refractive index of the layer of low refractive index is lower than the refractive index of the transparent base material.

The layers of high refractive index or the layers of low refractive index may not have the same refractive index. Preferably, the layers of high refractive index or the layers of low refractive index are formed of the same material and have the same refractive index from the viewpoint of suppressing material costs and film formation costs.

Examples of materials constituting the layer of low refractive index include silicon oxide, silicon oxynitride, gallium oxide, aluminum oxide, lanthanum oxide, lanthanum fluoride, magnesium fluoride, and sodium aluminum fluoride.

Examples of materials constituting the layer of high refractive index include niobium oxide, titanium oxide, zirconium oxide, tantalum oxide, silicon oxynitride, silicon nitride, silicon niobium oxide, and the like.

Among these, a combination of silicon oxide and silicon nitride and a combination of silicon oxide and titanium oxide are preferable since a difference in refractive index between the layer of high refractive index and the layer of low refractive index is large and the compositional ratio is relatively easily controlled.

By forming a film by controlling any of the compounds to have a constitutional atomic ratio deviated from the stoichiometric compositional ratio or controlling the film formation density, the refractive index can be changed to a certain degree.

For the film formation of each layer of the interlayer, it is preferable to use a vapor phase film formation method such as vacuum deposition, sputtering (such as plasma sputtering or electron cyclotron sputtering), or ion plating. According to the vapor phase film formation method, a laminated structure having various refractive indexes and film thicknesses can be easily formed.

The film thickness of each layer constituting the interlayer is preferably λ/(2×n) or less in a case where the wavelength of the reflection prevention target light is λ and the refractive index of the dielectric layer is n. In a case where the film thickness of each layer constituting the interlayer is λ/(2×n) or less, both the wavelength of which reflection is prevented and the wavelength of which reflection is enhanced are not included in a wavelength range of wavelengths of 400 nm, 550 nm, and 700 nm and thus it is possible to obtain an antireflection effect in a wide range.

<Anchor Layer>

It is preferable that the optical film of the present invention has an anchor layer formed of a metal other than silver between the metal layer and the interlayer from the viewpoint of easily setting the refractive index of the metal layer to 0.40 or less.

The details of the reason for easily setting the refractive index of the metal layer to 0.40 or less by forming the metal layer containing at least silver on the anchor layer are unknown. Here, since pure silver has a surface energy larger than that of the interlayer, the wettability is low and the film granularly grows instead of a smooth film in some cases. By forming the metal layer containing at least silver and having a film thickness of less than 5.0 nm on the anchor layer after forming the anchor layer, a difference in surface energy between the metal layer and the interlayer is adjusted to increase wettability and control the granulation to be in a preferable range. Thus, a metal film having high smoothness can be formed. It is considered that having high smoothness is related to easily setting the refractive index of the metal layer to 0.40 or less.

However, even in a case where the optical film of the present invention does not have the anchor layer formed of a metal other than silver between the metal layer and the interlayer, the refractive index of the metal layer can be set to 0.40 or less by controlling the film formation method of the metal layer. For example, by forming the metal layer by using electron beam (EB) deposition as a film formation method, the refractive index of the metal layer is easily controlled to be 0.40 or less. The reason for changing the refractive index of the metal layer due to differences in film formation methods is not clear. It is considered that by changing the degree of vacuum, film formation rate, temperature, and the like at the film formation of the metal layer, in a case where the metal layer is a polycrystalline film, the average particle diameter of particles, the surface unevenness of the metal layer, and the void state in the film of the metal layer are changed.

It is preferable to use a metal layer formed of a metal other than silver as the anchor layer. In the optical film of the present invention, the anchor layer is preferably formed of germanium, titanium, chromium, niobium, or molybdenum, more preferably formed of germanium or titanium, and particularly preferably formed of germanium. Germanium, titanium, chromium, niobium, and molybdenum have a common property of having a surface energy larger than the surface energy of the interlayer and thus any of these materials has a function of an anchor layer.

The film thickness of the anchor layer is not particularly limited. The film thickness of the anchor layer is preferably a film thickness which does not affect an antireflection effect due to the optical interference of the laminated structure of the transparent base material, the interlayer, the metal layer, and the dielectric layer. Specifically, in a case where the wavelength of the reflection prevention target light is λ and the refractive index of the dielectric layer is n, the film thickness of the anchor layer is preferably λ/(100n) or less and more preferably λ/(200n) or less.

In the optical film of the present invention, the film thickness of the anchor layer is preferably 0.2 nm to 2 nm. As long as the film thickness is 0.2 nm or more, the granulation of the metal layer to be formed thereon can be controlled to be in a preferable range. In addition, as long as the film thickness is 2 nm or less, the light absorption of the anchor layer itself can be suppressed and thus deterioration in the visible light transmittance of the optical film can be suppressed.

The film thickness of the anchor layer is more preferably 0.3 nm to 1.0 nm and particularly preferably 0.4 nm to 0.8 nm.

The method for forming the anchor layer is not particularly limited. As the method for forming the anchor layer, for example, it is preferable to use a vapor phase film formation method such as vacuum deposition, sputtering (such as plasma sputtering or electron cyclotron sputtering), or ion plating.

<Metal Layer>

The optical film of the present invention has a metal layer containing at least silver, the film thickness of the metal layer is less than 5.0 nm, and the refractive index (real part) of the metal layer is 0.40 or less.

In the present invention, the metal layer contains at least silver.

In the present specification, the expression “the metal layer contains silver” means that the metal layer contains 85% by atom or more of silver. In other words, the content of silver atoms in the metal layer is 85% by atom or more. The content of silver atoms in the metal layer is more preferably 95% by atom or more and particularly preferably 98% by atom or more.

It is preferable that the metal layer contains at least one of palladium (Pd), copper (Cu), gold (Au), neodymium (Nd), samarium (Sm), bismuth (Bi), or platinum (Pt), other than silver. As the material for constituting the metal layer 4, specifically, for example, an Ag—Nd—Cu alloy, an Ag—Pd—Cu alloy, an Ag—Pd—Nd alloy, an Ag—Bi—Nd alloy, or the like is suitably used. A thin film formed by using silver granularly grows in some cases, and by forming a film including about several percent of at least one of Nd, Cu, Bi, or Pd in Ag, a thin film having higher smoothness is easily formed. The content of metal atoms in the metal layer other than silver is preferably less than 15% by atom, more preferably 5% by atom or less, and particularly preferably 2% by atom or less. In a case where two or more kinds of metal atoms other than silver are included in the metal layer, the content of metal atoms in the metal layer other than silver refers to a total content of two or more kinds of metal atoms.

In the present invention, the film thickness of the metal layer is less than 5.0 nm, preferably 4.5 nm or less, and more preferably 4.2 nm or less.

The film thickness of the metal layer is preferably 2.0 nm or more, more preferably 2.5 nm or more, and particularly preferably 3 nm or more.

It is preferable that the height of the surface unevenness of the metal layer (a difference between a portion having the largest film thickness and a portion having the smallest film thickness) is small and the metal layer is smooth. It is preferable that the height of the surface unevenness of the metal layer is 10% or less of the film thickness of the metal layer from the viewpoint of reducing reflectivity.

In the present invention, the metal layer has a refractive index of 0.40 or less. However, the refractive index is a value measured at a wavelength of 550 nm.

The present inventors have found that in a case where the metal layer having a film thickness of less than 5.0 nm is formed, the refractive index is significantly changed due to the effect of the film formation method of the metal layer and the like and thus the refractive index can be made smaller than the refractive index of bulk metal. It is considered that this is because the refractive index is changed due to such states that as shown in the TEM image of the metal layer in FIG. 5, the metal layer having a film thickness of less than 5.0 nm is not a continuous film but is present in the form of a polycrystalline film and there is a large amount of surface unevenness or there are a large number of voids in the film.

The refractive index of the metal layer is preferably 0.05 to 0.40 and more preferably 0.05 to 0.35.

As the state of the metal layer, a single crystal film or a polycrystalline film is preferable. In a case of a polycrystalline film, since light absorption caused by light scattering at the grain boundary is suppressed, the average particle diameter of particles in the polycrystalline film is preferably 2 nm or more, more preferably 5 nm or more, and particularly preferably 10 nm or more. For the same reason, the area ratio of voids in the polycrystalline film is preferably 20% or less, more preferably 15% or less, and even more preferably 10% or less.

The film formation method of the metal layer is not particularly limited. As the film formation method of the metal layer, for example, it is preferable to use a vapor phase film formation method such as vacuum deposition, electron beam deposition, sputtering (such as plasma sputtering or electron cyclotron sputtering), or ion plating.

It is considered that by changing the degree of vacuum, film formation rate, temperature, and the like at the film formation of the metal layer, a method for controlling the state of the metal layer and the refractive index (real part) of the metal layer and preferable ranges of respective conditions are as follows.

The degree of vacuum at the film formation is preferably 1×10⁻³ Pa or less and more preferably 6×10⁻⁴ Pa or less.

The film formation rate at the film formation is preferably 0.05 Å/S to 8.0 Å/S and more preferably 0.1 Å/S to 6.0 Å/S. Here, 1 Å is 1×10⁻¹⁰ m.

The temperature at the film formation is preferably 400° C. or lower and more preferably 300° C. or lower.

<Dielectric Layer>

The optical film of the present invention has a dielectric layer.

The dielectric layer is not particularly limited. The refractive index n (refractive index real part) of the dielectric layer is preferably 1.35 or more and 1.51 or less, more preferably 1.35 or more and 1.50 or less, and particularly preferably 1.35 or more and 1.45 or less.

The material for the dielectric layer is not limited. For example, the dielectric layer preferably includes silicon oxide, silicon oxynitride, magnesium fluoride, and sodium aluminum fluoride. The dielectric layer preferably includes silicon oxide or magnesium fluoride and preferably includes magnesium fluoride from the viewpoint that the reflectivity can be lowered while maintaining rub resistance. By forming a film by controlling any of the compounds to have a constitutional atomic ratio deviated from the stoichiometric compositional ratio or controlling the film formation method, the refractive index can be changed to a certain degree.

The film thickness of the dielectric layer is preferably λ/(8n) to λ/(4n) in a case where the wavelength of the reflection prevention target light is λ and the refractive index of the dielectric layer is n. Specifically, the film thickness of the dielectric layer varies depending on the wavelength of the reflection prevention target light and the refractive index of the dielectric layer. For example, in a case where λ=550 nm and n=1.38, the film thickness of the dielectric layer is preferably 50 nm to 100 nm.

The method for forming the dielectric layer is not particularly limited. As the method for forming the dielectric layer, it is preferable to use a vapor phase film formation method such as vacuum deposition, electron beam deposition, sputtering (such as plasma sputtering or electron cyclotron sputtering), or ion plating.

[Optical Element]

An optical element of the present invention has the optical film of the present invention.

The optical film of the present invention can be applied to various optical elements. As the optical element, an optical lens may be mentioned. Particularly, the optical element is preferably a lens having a high refractive index.

[Optical System]

An optical system of the present invention has a group lens including a plurality of lenses and has an optical system in which a lens at the outermost surface in the group lens has the optical film of the present invention.

The optical system of the present invention preferably has the optical element of the present invention.

As the optical system, for example, a known zoom lens disclosed in JP2011-186417A is preferable.

An example of the optical system which has a group lens including a plurality of lenses and in which a lens at the outermost surface in the group lens has the optical film of the present invention will be described with reference to the drawing.

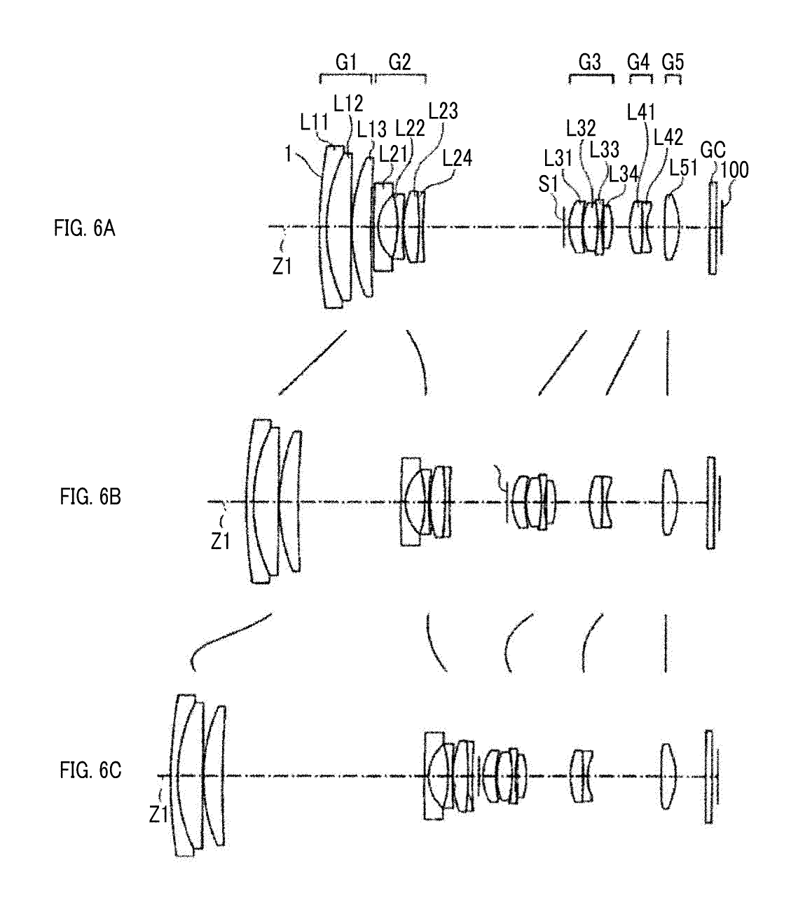

FIGS. 6A, 6B and 6C are schematic view showing an example of a configuration of the optical system of the present invention. FIGS. 6A, 6B and 6C respectively show configuration examples of a zoom lens which is an embodiment of the optical system of the present invention. FIG. 6A corresponds to the arrangement of the optical system at a wide angle end (shortest focal length state), FIG. 6B corresponds to the arrangement of the optical system in a middle range (middle focal length state), and FIG. 6C corresponds to the arrangement of the optical system at the telephoto end (longest focal length state).

The zoom lens shown in FIGS. 6A, 6B and 6C includes a first lens group G1, a second lens group G2, a third lens group G3, a fourth lens group G4, and a fifth lens group G5, which are arranged along an optical axis Z1 in this order from the object side. It is preferable that an optical aperture stop S1 is arranged between the second lens group G2 and the third lens group G3 and is arranged in the vicinity of the object side of the third lens group G3. Each of the lens groups G1 to G5 includes one lens Lij or a plurality of lenses Lij. The symbol Lij represents a j-th lens in which a number j is given to each lens in a serially increasing manner toward the image formation side with a lens closest to the object side being taken as the first lens in an i-th lens group. The image formation side is the right side in the page of FIGS. 6A, 6B and 6C.

The zoom lens shown in FIGS. 6A, 6B and 6C can be mounted on, for example, an information portable terminal, as well as a capturing device such as a video camera or a digital camera. On the image side of the zoom lens shown in FIGS. 6A, 6B and 6C, it is preferable to arrange members according to a configuration of a capturing section of a camera to be mounted. For example, an imaging element 100 such as a charge coupled device (CCD) or a complementary metal oxide semiconductor (CMOS) is preferably arranged on the image formation surface (imaging surface) of the zoom lens shown in FIGS. 6A, 6B and 6C. Various optical members GC based on the structure of the camera side on which the lens is mounted may be arranged between the last lens group (fifth lens group G5) and the imaging element 100.

It is preferable that the magnification of the zoom lens shown in FIGS. 6A, 6B and 6C is changed by moving at least the first lens group G1, the third lens group G3, and the fourth lens group G4 along the optical axis Z1 and changing the interval between the respective lens groups. In addition, the fourth lens group G4 may be moved at the time of focusing. It is preferable that the fifth lens group G5 is normally fixed in a case of magnification change and focusing. It is preferable that the aperture stop S1 moves together with, for example, the third lens group G3. More specifically, it is preferable that with the change from the wide angle end to the middle range and further to the telephoto end, each lens group and the aperture stop S1 move so as to draw loci indicated by solid lines in the drawings for example, from a state of FIG. 6A to the state of FIG. 6B and further to the state of FIG. 6C.

At the outermost surface of the zoom lens shown in FIGS. 6A, 6B and 6C, the optical film 1 of the present invention is preferably provided on the outside side surface (object side surface) of the lens L11 of the first lens group G1. Similarly, the optical film 1 of the present invention may be provided on the surfaces of lenses other than the lens L11 (not shown). For example, an aspect in which the optical film 1 of the present invention is provided on the outside side surface of the lens L51 of the fifth lens group G5 which is the last lens group is preferable (not shown).

Since the optical film of the present invention has excellent rub resistance, the optical film can be provided on the outermost surface of the zoom lens that may be touched by a user and a zoom lens exhibiting very high antireflection performance can be formed.

### EXAMPLES

Hereinafter, the present invention will be specifically described with reference to Examples. However, the present invention is not limited to these Examples.

### Examples 1 to 17 Comparative Examples 1 to 9

<Preparation of Transparent Base Material>

In each of Examples and Comparative Examples, a transparent base material shown in Table 4 was prepared.

The details of each of the prepared transparent base materials are shown. The visible light transmittance of the transparent base material was measured in the same manner as in the measurement of the visible light transmittance of the optical film described later.

S-NBH5 is a transparent base material having a refractive index of 1.66393 and a visible light transmittance of 88.0% and is manufactured by Ohara Inc.

Quartz is a transparent base material having a refractive index of 1.46 and a visible light transmittance of 92.0% and is a manufactured by Shin-Etsu Chemical Co., Ltd.

S-LAL18 is a transparent base material having a refractive index of 1.73702 and a visible light transmittance of 87.0% and is manufactured by Ohara Inc.

FDS90 is a transparent base material having a refractive index of 1.86814 and a visible light transmittance of 84.0% and is manufactured by HOYA Corporation.

Each of the prepared transparent base materials was subjected to ultrasonic cleaning with acetone and methanol and dried with nitrogen blowing.

<Film Formation of Interlayer>

In Examples 1 to 17 and Comparative Examples 1 to 6, 8, and 9, interlayers shown in Table 4 were respectively formed on the dried transparent base material using a sputtering device manufactured by JSW AFTY Corporation.

The details of each of the formed interlayers are shown in Tables 1 to 3. A SiO₂ film having a refractive index of 1.46235, a SiN film having a refractive index of 1.98, a TiO₂ film having a refractive index of 2.31, and a ZnO film having a refractive index of 2.02 were used respectively. In a case where the interlayer includes two or more layers, the layer shown on the upper side of the page of Tables 1 to 3 is on the transparent base material side and the layer shown on the lower side of the page is on the metal layer side (in a case of providing an anchor layer, the anchor layer side).

TABLE 1

| | Interlayer | | | | | | |
|---|---|---|---|---|---|---|---|
| | 1-layer | 2-layer | 4-layer | 4-layer | 4-layer | 6-layer | 8-layer |
| | A | A | A | B | C | A | A |
| Silicon | 22.0 | 11.3 | 26.4 | 27.3 | 30.2 | 28.9 | 28.4 |
| nitride | | | | | | | |
| [nm] | | | | | | | |
| Silicon | — | 135.0 | 83.7 | 79.0 | 68.3 | 81.4 | 83.2 |
| oxide | | | | | | | |
| [nm] | | | | | | | |
| Silicon | — | — | 10.5 | 14.1 | 22.2 | 16.4 | 15.5 |
| nitride | | | | | | | |
| [nm] | | | | | | | |
| Silicon | — | — | 41.0 | 35.2 | 28.9 | 51.3 | 52.5 |
| oxide | | | | | | | |
| [nm] | | | | | | | |
| Silicon | — | — | — | — | — | 15.1 | 16.6 |
| nitride | | | | | | | |
| [nm] | | | | | | | |
| Silicon | — | — | — | — | — | 4.4 | 13.4 |
| oxide | | | | | | | |
| [nm] | | | | | | | |
| Silicon | — | — | — | — | — | — | 3.9 |
| nitride | | | | | | | |
| [nm] | | | | | | | |
| Silicon | — | — | — | — | — | — | 2.8 |
| oxide | | | | | | | |
| [nm] | | | | | | | |

TABLE 2

| Interlayer | 2-layer B |
|---|---|
| Titanium oxide [nm] | 22.2 |
| Silicon oxide [nm] | 172.1 |

TABLE 3

| Interlayer | 1-layer B |
|---|---|
| Zinc oxide [nm] | 31.5 |

<Film Formation of Anchor Layer>

In Examples 1 to 16 and Comparative Examples 2 to 6 and 8, anchor layers of the kinds and film thicknesses shown in Table 4 were respectively formed on the formed interlayer using a sputtering device manufactured by SHIBAURA MECHATRONICS CORPORATION.

In Comparative Example 7, anchor layers of the kind and film thickness shown in Table 4 were respectively formed on the dried transparent base material using a sputtering device manufactured by SHIBAURA MECHATRONICS CORPORATION.

<Film Formation of Metal Layer>

In Examples 1 to 16 and Comparative Examples 2 to 8, metal layers of the kinds and film thicknesses shown in Table 4 were respectively formed on the formed anchor layers using a sputtering device manufactured by SHIBAURA MECHATRONICS CORPORATION. In Examples 1 to 16 and Comparative Examples 2 to 8, the degree of vacuum, film formation rate, and temperature at the film formation of the metal layer were as follows.

The degree of vacuum at the film formation was 6.0×10⁻⁴ Pa.

The film formation rate at the film formation was 2.2 Å/S.

The temperature at the film formation was 25° C.

In Comparative Examples 1 and 9, metal layers of the kinds and film thicknesses shown in Table 4 were respectively formed on the formed interlayers (without interposing an anchor layer) using a sputtering device manufactured by SHIBAURA MECHATRONICS CORPORATION under the same conditions as in Example 1.

In Example 17, a metal layer of the kind and film thickness shown in Table 4 was formed on the formed interlayer (without interposing an anchor layer) using an electron beam (EB) deposition device manufactured by ULVAC TECHNO, Ltd. In Example 17, the degree of vacuum, film formation rate, and temperature at the film formation of the metal layer were as follows.

The degree of vacuum at the film formation was 2.0×10⁻⁴ Pa.

The film formation rate at the film formation was 1.0 Å/S.

The temperature at the film formation was 30° C.

The details of the metal layer formed in each of Examples and Comparative Examples are shown.

“Ag” is a metal layer formed by using pure silver as a target.

“GBD05” is a metal layer formed by using GBD05 (manufactured by Kobelco Research Institute, Inc.) which is a silver alloy target (Ag-0.35% Bi-0.2% Nd) as a target.

“APC” is a metal layer formed by using APC (manufactured by FURUYA METAL CO., LTD.) which is a silver alloy target (Ag—Pd—Nd) as a target.

(Refractive Index and Film Thickness of Metal Layer)

Regarding the metal layer prepared in each of Examples and Comparative Examples, the refractive index of the metal layer with respect to a wavelength of 550 nm and the film thickness of the metal layer were evaluated using a spectroscopic ellipsometer manufactured by Five Lab Co., Ltd. The results were collectively shown in Tables 4 and 5. As shown in Table 5, it was found that the refractive index of the metal layer varied according to the preparation method.

<Film Formation of Dielectric Layer>

A dielectric layer of the kind and film thicknesses shown in Table 4 was formed on the metal layer prepared in each of Examples and Comparative Examples by a deposition method using an electron beam (EB) deposition device manufactured by ULVAC TECHNO, Ltd.

The laminate with the dielectric layer formed therein was used as an optical film in each of Examples and Comparative Examples.

(Refractive Index and Film Thickness of Dielectric Layer)

Regarding the dielectric layer prepared in each of Examples and Comparative Examples, the refractive index of the dielectric layer with respect to a wavelength of 550 nm and the film thickness of the dielectric layer were evaluated using a spectroscopic ellipsometer manufactured by Five Lab Co., Ltd.

The refractive index of the dielectric layer which is a film of magnesium fluoride used in each of Examples was 1.38.

TABLE 4

| | | | | Anchor layer | | Metal layer | | Dielectric layer | |
|---|---|---|---|---|---|---|---|---|---|
| | | Transparent | | | Film | | Film | | Film |
| | | base | | | thickness | | thickness | | thickness |
| | No. | material | Interlayer | Kind | (nm) | Kind | (nm) | Kind | (mil) |
| Comparative | 1 | S-NBH5 | 4-layer A | — | — | Ag | 4.0 | Magnesium | 82.82 |
| Example | | | | | | | | fluoride | |
| Comparative | 2 | S-NBH5 | 4-layer A | Ge | 0.1 | Ag | 4.0 | Magnesium | 82.82 |
| Example | | | | | | | | fluoride | |
| Comparative | 3 | S-NBH5 | 4-layer A | Ge | 0.2 | Ag | 4.0 | Magnesium | 82.82 |
| Example | | | | | | | | fluoride | |
| Example | 1 | S-NBH5 | 4-layer A | Ge | 0.3 | Ag | 4.0 | Magnesium | 82.82 |
| | | | | | | | | fluoride | |
| Example | 2 | S-NBH5 | 4-layer A | Ge | 0.5 | Ag | 4.0 | Magnesium | 82.82 |
| | | | | | | | | fluoride | |
| Example | 3 | S-NBH5 | 4-layer A | Ge | 1.0 | Ag | 4.0 | Magnesium | 82.82 |
| | | | | | | | | fluoride | |
| Example | 4 | S-NBH5 | 4-layer A | Ti | 0.5 | Ag | 4.0 | Magnesium | 82.82 |
| | | | | | | | | fluoride | |
| Example | 5 | S-NBH5 | 4-layer A | Ge | 0.5 | GBD05 | 4.0 | Magnesium | 82.82 |
| | | | | | | | | fluoride | |
| Example | 6 | S-NBH5 | 4-layer A | Ge | 0.5 | APC | 4.0 | Magnesium | 82.82 |
| | | | | | | | | fluoride | |
| Example | 7 | S-NBH5 | 4-layer A | Ge | 0.5 | Ag | 3.2 | Magnesium | 82.82 |
| | | | | | | | | fluoride | |
| Example | 8 | S-NBH5 | 4-layer A | Ge | 0.5 | Ag | 3.6 | Magnesium | 82.82 |
| | | | | | | | | fluoride | |
| Example | 9 | S-NBH5 | 4-layer A | Ge | 0.5 | Ag | 4.4 | Magnesium | 82.82 |
| | | | | | | | | fluoride | |
| Example | 10 | S-NBH5 | 4-layer A | Ge | 0.5 | Ag | 4.8 | Magnesium | 82.82 |
| | | | | | | | | fluoride | |
| Comparative | 4 | S-NBH5 | 4-layer A | Ge | 0.5 | Ag | 5.2 | Magnesium | 82.82 |
| Example | | | | | | | | fluoride | |
| Comparative | 5 | S-NBH5 | 4-layer A | Ge | 0.5 | Ag | 5.6 | Magnesium | 82.82 |
| Example | | | | | | | | fluoride | |
| Comparative | 6 | S-NBH5 | 4-layer A | Ge | 0.5 | Ag | 6.0 | Magnesium | 82.82 |
| Example | | | | | | | | fluoride | |
| Comparative | 7 | S-NBH5 | None | Ge | 0.5 | Ag | 4.0 | Magnesium | 71.50 |
| Example | | | | | | | | fluoride | |
| Example | 11 | S-NBH5 | 2-layer A | Ge | 0.5 | Ag | 4.0 | Magnesium | 70.88 |
| | | | | | | | | fluoride | |
| Example | 12 | S-NBH5 | 6-layer A | Ge | 0.5 | Ag | 4.0 | Magnesium | 84.50 |
| | | | | | | | | fluoride | |
| Example | 13 | S-NBH5 | 8-layer A | Ge | 0.5 | Ag | 4.0 | Magnesium | 84.35 |
| | | | | | | | | fluoride | |
| Example | 14 | Quartz | 1-layer A | Ge | 0.5 | Ag | 4.0 | Magnesium | 81.30 |
| | | | | | | | | fluoride | |
| Example | 15 | S-LAL18 | 4-layer B | Ge | 0.5 | Ag | 4.0 | Magnesium | 83.50 |
| | | | | | | | | fluoride | |
| Example | 16 | FDS90 | 4-layer C | Ge | 0.5 | Ag | 4.0 | Magnesium | 83.90 |
| | | | | | | | | fluoride | |
| Example | 17 | S-NBH5 | 4-layer A | — | — | Ag | 4.0 | Magnesium | 82.82 |
| | | | | | | | | fluoride | |
| Example | 8 | Quartz | 2-layer B | Ge | 0.5 | Ag | 6.5 | Comparative | 78.00 |
| | | | | | | | | Silicon oxide | |
| Comparative | 9 | Quartz | 1-layer B | — | — | Ag | 6.4 | Silicon oxide | 71.00 |
| Example | | | | | | | | | |

<Evaluation>

(Visible Light Transmittance)

Regarding the optical film in each of Examples and Comparative Examples, the spectral transmittance was measured using a spectrophotometer U4000 manufactured by Hitachi Corporation. The visible light transmittance was evaluated from the obtained spectral transmittance according to the method described in JIS R 3106:1998. JIS is an abbreviation of the Japanese Industrial Standards (JIS). The obtained visible light transmittance of the optical films was shown in Table 5.

The obtained visible light transmittance of the optical films was evaluated based on the following standards. The obtained evaluation results were shown in Table 5.

OK: The visible light transmittance of the optical film is higher than the visible light transmittance of the transparent base material.

NG: The visible light transmittance of the optical film is equal to or lower than the visible light transmittance of the transparent base material.

(Reflectivity)

Regarding the dielectric layer side surfaces of the optical film in each of Examples and Comparative Examples, the spectral reflectivity (which has the same meaning as “spectral surface reflectivity” since the spectral reflectivity is measured on the surface of the optical film) was measured using reflecting spectrographic film thickness meter FE3000 manufactured by OTSUKA ELECTRONICS Co., LTD. Among the obtained spectral reflectivity values, the reflectivity with respect to wavelengths of 400 nm, 550 nm, and 700 nm was shown in Table 5.

The obtained reflectivity of the optical films was evaluated according to the following standards. The obtained evaluation results were shown in Table 5.

OK: The reflectivity of the optical film is 0.50% or less with respect to all wavelengths of 400 nm, 550 nm, and 700 nm.

NG: The reflectivity of the optical film is more than 0.50% with respect to at least one of wavelengths of 400 nm, 550 nm, and 700 nm.

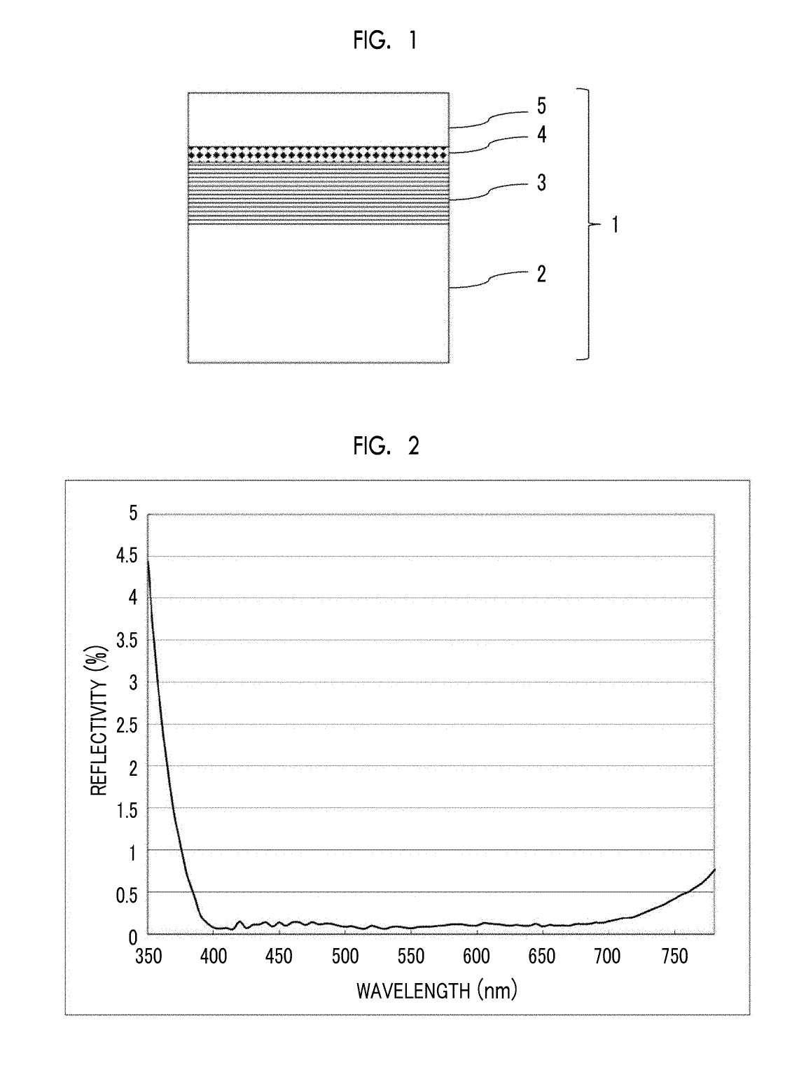

Among the spectral reflectivity values of the optical films, for example, the graph of the spectral reflectivity of the optical film of Example 5 is shown in FIG. 2. In the graph in FIG. 2, the horizontal axis represents a wavelength and the vertical axis represents reflectivity. From FIG. 2, it is found that a reflectivity of 0.50% or less was obtained in a wide wavelength range of 400 nm to 700 nm in the optical film of Example 5.

(Rub Resistance)

The fabric to which weight of 200 g/cm² was applied was reciprocated 500 times on the dielectric layer of the optical film of Example 1 to conduct a rub resistance test. As a result of conducting evaluation on reflectivity again after the rub resistance test, the reflectivity with respect to wavelengths of 400 nm, 550 nm, and 700 nm was respectively 0.22%, 0.14%, and 0.42%.

As a result of comparison with the reflectivity shown in Table 5 (reflectivity before rub resistance test), it was found that there was a small change in reflectivity before the rub resistance test and after the rub resistance test. It was found that the optical film of Example 1 had excellent rub resistance. In addition, it was found that similar to Example 1, the optical films of Examples 2 to 17 in which the dielectric layer was the outermost layer had excellent rub resistance.

(Total Evaluation)

The total evaluation of the optical film in each of Examples and Comparative Examples was conducted based on the following standards. The obtained evaluation results were shown in Table 5. Practically, it is necessary that the evaluation result is OK.

OK: Both the evaluation of visible light transmittance and the evaluation of reflectivity are OK.

NG: At least one of the evaluation of visible light transmittance or the evaluation of reflectivity is NG.

TABLE 5

| | | Visible light | Refractive | Visible light | | | | | | |
|---|---|---|---|---|---|---|---|---|---|---|
| | | transmittance of | index of | transmittance | | Reflectivity | | | | |
| | | transparent base | metal layer | Optical | | Reflectivity | Reflectivity | Reflectivity | | Total |
| | No | material | (550 nm) | film | Evaluation | (400 nm) | (550 nm) | (700 nm) | Evaluation | evaluation |
| Comparative | 1 | 88.0% | 0.95 | 80.2% | NO | 0.34% | 0.48% | 1.73% | NO | NO |
| Example | | | | | | | | | | |
| Comparative | 2 | 88.0% | 0.71 | 84.3% | NO | 0.22% | 0.33% | 1.11% | NO | NO |
| Example | | | | | | | | | | |
| Comparative | 3 | 88.0% | 0.45 | 87.5% | NO | 0.16% | 0.11% | 0.65% | NO | NO |
| Example | | | | | | | | | | |
| Example | 1 | 88.0% | 0.38 | 88.3% | OK | 0.20% | 0.12% | 0.45% | OK | OK |
| Example | 2 | 88.0% | 0.32 | 89.8% | OK | 0.10% | 0.06% | 0.32% | OK | OK |
| Example | 3 | 88.0% | 0.26 | 90.3% | OK | 0.15% | 0.12% | 0.38% | OK | OK |
| Example | 4 | 88.0% | 0.35 | 88.5% | OK | 0.18% | 0.13% | 0.42% | OK | OK |
| Example | 5 | 88.0% | 0.22 | 91.4% | OK | 0.08% | 0.08% | 0.15% | OK | OK |
| Example | 6 | 88.0% | 0.23 | 91.0% | OK | 0.11% | 0.07% | 0.15% | OK | OK |
| Example | 7 | 88.0% | 0.33 | 90.3% | OK | 0.09% | 0.35% | 0.28% | OK | OK |
| Example | 8 | 88.0% | 0.25 | 90.1% | OK | 0.07% | 0.17% | 0.16% | OK | OK |
| Example | 9 | 88.0% | 0.26 | 89.4% | OK | 0.13% | 0.06% | 0.38% | OK | OK |
| Example | 10 | 88.0% | 0.23 | 89.0% | OK | 0.21% | 0.07% | 0.42% | OK | OK |
| Comparative | 4 | 88.0% | 0.28 | 88.5% | OK | 0.30% | 0.25% | 1.05% | NO | NO |
| Example | | | | | | | | | | |
| Comparative | 5 | 88.0% | 0.24 | 88.0% | NO | 0.46% | 0.39% | 1.81% | NO | NO |
| Example | | | | | | | | | | |
| Comparative | 6 | 88.0% | 0.25 | 87.3% | NO | 0.63% | 0.66% | 2.53% | NO | NO |
| Example | | | | | | | | | | |
| Comparative | 7 | 88.0% | 0.32 | 89.3% | OK | 1.70% | 0.65% | 2.98% | NO | NO |
| Example | | | | | | | | | | |
| Example | 11 | 88.0% | 0.31 | 89.1% | OK | 0.41% | 0.29% | 0.32% | OK | OK |
| Example | 12 | 88.0% | 0.35 | 90.1% | OK | 0.09% | 0.08% | 0.12% | OK | OK |
| Example | 13 | 88.0% | 0.33 | 90.3% | OK | 0.08% | 0.08% | 0.11% | OK | OK |
| Example | 14 | 92.0% | 0.36 | 92.2% | OK | 0.23% | 0.09% | 0.33% | OK | OK |
| Example | 15 | 87.0% | 0.38 | 87.2% | OK | 0.09% | 0.08% | 0.12% | OK | OK |
| Example | 16 | 84.0% | 0.35 | 84.1% | OK | 0.12% | 0.08% | 0.13% | OK | OK |
| Example | 17 | 88.0% | 0.40 | 88.1% | OK | 0.21% | 0.15% | 0.44% | OK | OK |
| Comparative | 8 | 92.0% | 0.35 | 92.5% | OK | 1.30% | 0.03% | 0.60% | NO | NO |
| Example | | | | | | | | | | |
| Comparative | 9 | 92.0% | 0.71 | 84.4% | NO | 1.10% | 0.22% | 0.46% | NO | NO |
| Example | | | | | | | | | | |

From the above, it was found that the optical film of the present invention had a reflectivity of 0.50% or less with respect to all wavelengths of 400 nm, 550 nm, and 700 nm and had a visible light transmittance higher than the visible light transmittance of the transparent base material and excellent rub resistance.

On the other hand, from Comparative Examples 1 to 3, it was found that the optical films having a refractive index of more than 0.40 of the metal layer had a visible light transmittance equal to or lower than the light transmittance of the transparent base material and a reflectivity of more than 0.50% with respect to at least one of wavelengths of 400 nm, 550 nm, and 700 nm.

From Comparative Examples 4 to 6, it was found that the optical films having a film thickness of 5.0 nm or more of the metal layer had a reflectivity of more than 0.50% with respect to at least one of wavelengths of 400 nm, 550 nm, and 700 nm. Further, from Comparative Example 6, it was found that the optical film in which the film thickness of the metal layer considerably exceeded 5.0 nm had a reflectivity of more than 0.50% with respect to at least one of wavelengths of 400 nm, 550 nm, and 700 nm, and a visible light transmittance higher than that of the transparent base material.

From Comparative Example 7, it was found that the optical film not having an interlayer had a reflectivity of more than 0.50% with respect to at least one of wavelengths of 400 nm, 550 nm, and 700 nm.

From the reflectivity measurement result in Comparative Example 8, it was found that in the structure similar to Example 1-A disclosed in JP2013-238709A, the reflectivity with respect to at least one of wavelengths of 400 nm, 550 nm, and 700 nm was more than 0.50%. That is, it was found that in the structure similar to Example 1-A disclosed in JP2013-238709A, an antireflection effect could not be obtained in a wide wavelength range of a visible light range.

From the measurement results of the visible light transmittance and the reflectivity in Comparative Example 9, it was found that in the structure similar to Example 1 disclosed in JP4560889B, the visible light transmittance was equal to or lower than the light transmittance of the transparent base material and the reflectivity with respect to at least one of wavelengths of 400 nm, 550 nm, and 700 nm was more than 0.50%. That is, in the structure similar to Example 1 disclosed in JP4560889B, a visible light transmittance higher than the visible light transmittance of the transparent base material (quartz: 92.0%) could not be obtained and an antireflection effect could not be obtained in a wide wavelength range of a visible light range.

The details of each of Examples and Comparative Examples will be described below.

From the measurement results of the visible light transmittance and the reflectivity in Examples 2, and 11 to 13 and Comparative Example 7, it was found that, in a case where an interlayer was provided, an antireflection effect could be obtained in a wide wavelength range of a visible light range and a visible light transmittance higher than that of the transparent base material could be obtained.

From the measurement results of the visible light transmittance and the reflectivity in Examples 2, and 14 to 16, it was found that by using various kinds of transparent base materials in the present invention, an antireflection effect could be obtained in a wide wavelength range of a visible light range. It was found that the visible light transmittance of the optical film of each of Examples was higher than the visible light transmittance of the transparent base material (S-NBH5: 88.0%, quartz: 92.0%, S-LAL18: 87.0%, FDS90: 84.0%).

Regarding the optical films not having an anchor layer of Example 17 and Comparative Example 1, from the measurement results of the refractive index of the metal layer, it was found that, in a case where an anchor layer was not provided, the refractive index of the metal layer varied due to differences in film formation methods for the metal layer.

Further, regarding the optical films in Example 17 and Comparative Example 1, from the measurement results of the visible light transmittance and the reflectivity, it was found, that in a case where the refractive index of the metal layer was 0.40 or less, the visible light transmittance was higher than the visible light transmittance (88.0%) of S-NBH5 which is a transparent base material. In addition, it was found that the reflectivity with respect to all wavelengths of 400 nm, 550 nm, and 700 nm was 0.50% or less.

(Effect of Refractive Index of Metal Layer)

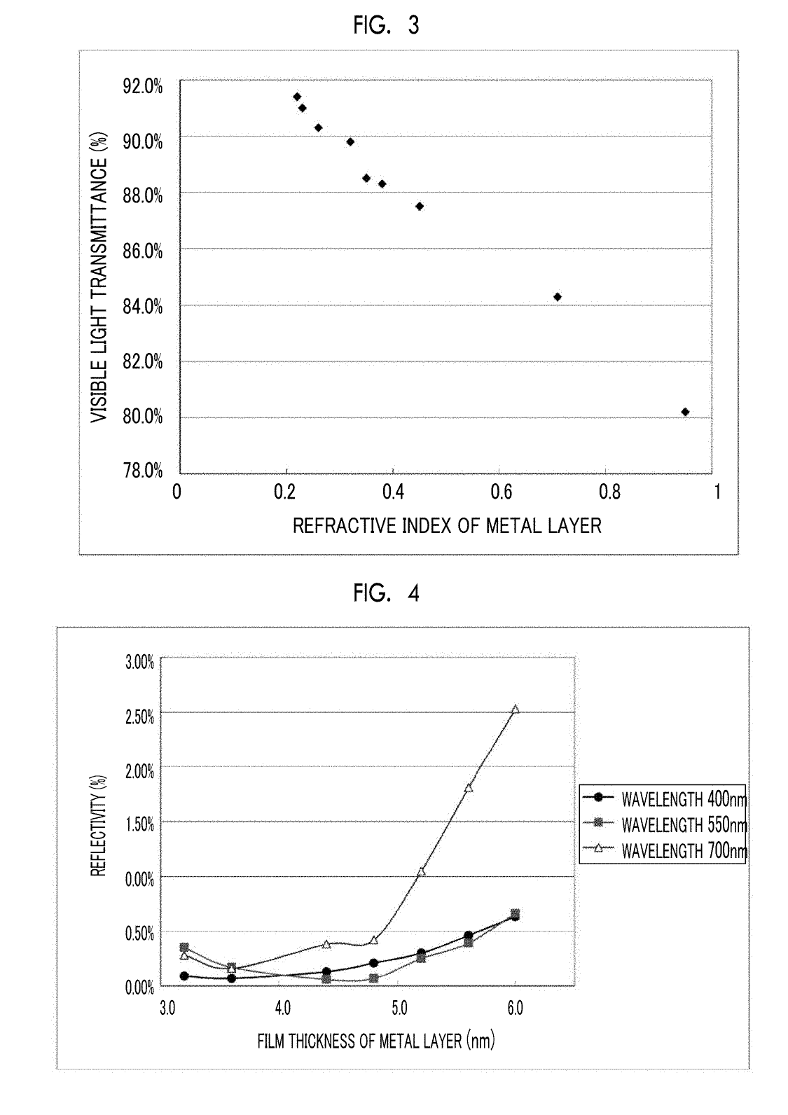

FIG. 3 is a graph showing a relationship between visible light transmittance and refractive index of the metal layer in Examples and Comparative Examples in which in a case where the film thickness of the metal layer is 4 nm, S-NBH5 was used as a transparent base material and only the film formation method for the metal layer was different (that is, Examples 1 to 6 and Comparative Examples 1 to 3).

From the results in FIG. 3, it was found that, in a case where the refractive index of the metal layer was 0.40 or less, the visible light transmittance was higher than the visible light transmittance (88.0%) of S-NBH5 which is a transparent base material. On the other hand, it was found that, in a case where the refractive index of the metal layer was more than 0.40, the visible light transmittance was lower than that of the transparent base material.

(Effect of Film Thickness of Metal Layer)

FIG. 4 is a graph showing a relationship between reflectivity with respect to wavelengths of 400 nm, 550 nm, and 700 nm and film thickness of the metal layer in Examples and Comparative Examples in which only the film thickness of the metal layer was changed and other conditions were adjusted (that is, Examples 7 to 10 and Comparative Examples 5 to 7).

From the results of FIG. 4, it was found that, in a case where the film thickness of the metal layer was less than 5.0 nm, a reflectivity of 0.50% or less was obtained in a wide wavelength range of wavelengths of 400 nm, 550 nm, and 700 nm. On the other hand, it was found that, in a case where the film thickness of the metal layer was 5.0 nm or more, the reflectivity at 700 nm was more than 0.50%.

In the optical film of each of Examples, the height of the surface unevenness of the metal layer was 1% to 10% of the film thickness of the metal layer. The height of the surface unevenness of the metal layer was obtained from the surface state measured using an atomic force microscope (AFM, model number: SPA400) manufactured by Seiko Instruments Inc.

(TEM Image of Metal Layer)

The metal layer used in the optical film in Example 5 was captured using a transmission electron microscope (model number: Titan 80-300) manufactured by Thermo Fisher Scientific. The obtained TEM image was shown in FIG. 5.

From FIG. 5, it was found that the metal layer used in the optical film in Example 5 was a polycrystalline film and the average particle diameter of particles in the polycrystalline film was 10 nm or more. The average particle diameter of particles in the polycrystalline film is a value obtained in the following method.

From the image captured by dark field TEM observation, the average particle diameter value of 100 particles was obtained and the obtained value was used as the average particle diameter of particles in the polycrystalline film.

In addition, it was found that in the metal layer used in the optical film of Example 5, and the area ratio of voids in the polycrystalline film was 10% or less.

The area ratio of voids in the polycrystalline film is a value obtained by the following method.

From the image captured by dark field TEM observation, the area of the entire view filed and the area of voids were investigated and as a result, the area of the entire view filed and the area of voids were receptively A and B. The ratio B/A was used as the area ratio of voids in the polycrystalline film.

As a result of observing the TEM images of the metal layers used in the optical films of other Examples in the same manner, it was found that the metal layer used in the optical film in each of Examples was a polycrystalline film and the average particle diameter of particles in the polycrystalline film was 10 nm or more. In addition, it was found that the area ratio of voids in the polycrystalline film was 10% or less.

### Example 18

<Optical System>

The optical system of the present invention was prepared as Example 18. Specifically, a zoom lens having a configuration described in Example 6 and FIG. 4 of JP2011-186417A was assembled and the optical film in Example 1 was used as an antireflection film. The zoom lens having the configuration shown in FIG. 4 of JP2011-186417A has the same configuration as the zoom lens shown in FIGS. 6A, 6B and 6C of the present specification. Hereinafter, description will be made with reference to FIGS. 6A, 6B and 6C of the present specification.

Specifically, the optical film in Example 1 of the present specification was provided on the outside side surface of lens L11 of the first lens group G1, which becomes the outermost surface of the group lens (in FIGS. 6A, 6B and 6C, the left side surface on the page). Antireflection films using a dielectric multilayer film other than the optical film in Example 1 were provided on optical surfaces other than this surface. The obtained optical system was used as the optical system in Example 18.

On the other hand, a zoom lens having the configuration described in Example 6 and FIG. 4 of JP2011-186417A (that is, FIGS. 6A, 6B and 6C in the present specification) was assembled and the above-described antireflection films using a dielectric multilayer film (other than the optical film in Example 1) were provided on all of the optical surfaces as in Example 18 of the present specification. The obtained optical system was used as an optical system in Reference Example 1.

The lens data and the reflectivity of each surface described in Example 1 of JP2011-186417A were used to analyze a ghost occurring on the surface of the imaging element 100 using ray tracing software Zemax OpticStudio produced by Zemax, LLC.

As a result, it was found that the ghost level could be suppressed in the optical system of Example 18 compared to the optical system of Reference Example 1. It is considered that the ghost level can be suppressed because the reflectivity of the optical film of the present invention is low (0.50% or less) with respect to all wavelengths of 400 nm, 550 nm, and 700 nm.

### EXPLANATION OF REFERENCES

1: optical film
2: transparent base material
3: interlayer
4: metal layer
5: dielectric layer
100: imaging element
G1: first lens group
G2: second lens group
G3: third lens group
G4: fourth lens group
G5: fifth lens group
GC: optical member
Lij: lens (j-th lens in which number j is given to each lens in serially increasing manner toward image formation side with lens closest to object side being taken as first lens in i-th lens group)
S1: aperture stop
Z1: optical axis

What is claimed is:

1. An optical film comprising:
a transparent base material;
a dielectric layer;
a metal layer having an interface with the dielectric layer and containing at least silver; and
an interlayer positioned between the metal layer and the transparent base material,
wherein a film thickness of the metal layer is less than 5.0 nm, and
the metal layer has a refractive index of 0.40 or less with respect to a wavelength of 550 nm.

2. The optical film according to claim 1, further comprising:
an anchor layer formed of a metal other than silver between the metal layer and the interlayer.

3. The optical film according to claim 2,
wherein the anchor layer is formed of germanium, titanium, chromium, niobium, or molybdenum.

4. The optical film according to claim 2,
wherein a film thickness of the anchor layer is 0.2 nm to 2 nm.

5. The optical film according to claim 3,
wherein a film thickness of the anchor layer is 0.2 nm to 2 nm.

6. The optical film according to claim 1,
wherein the metal layer is a silver alloy containing at least one kind of metal atoms other than silver.

7. The optical film according to claim 2,
wherein the metal layer is a silver alloy containing at least one kind of metal atoms other than silver.

8. The optical film according to claim 3,
wherein the metal layer is a silver alloy containing at least one kind of metal atoms other than silver.

9. The optical film according to claim 4,
wherein the metal layer is a silver alloy containing at least one kind of metal atoms other than silver.

10. The optical film according to claim 5,
wherein the metal layer is a silver alloy containing at least one kind of metal atoms other than silver.

11. The optical film according to claim 1 having a reflectivity of 0.50% or less with respect to all wavelengths of 400 nm, 550 nm, and 700 nm.

12. The optical film according to claim 2 having a reflectivity of 0.50% or less with respect to all wavelengths of 400 nm, 550 nm, and 700 nm.

13. The optical film according to claim 3 having a reflectivity of 0.50% or less with respect to all wavelengths of 400 nm, 550 nm, and 700 nm.

14. The optical film according to claim 4 having a reflectivity of 0.50% or less with respect to all wavelengths of 400 nm, 550 nm, and 700 nm.

15. The optical film according to claim 5 having a reflectivity of 0.50% or less with respect to all wavelengths of 400 nm, 550 nm, and 700 nm.

16. The optical film according to claim 6 having a reflectivity of 0.50% or less with respect to all wavelengths of 400 nm, 550 nm, and 700 nm.

17. The optical film according to claim 7 having a reflectivity of 0.50% or less with respect to all wavelengths of 400 nm, 550 nm, and 700 nm.

18. The optical film according to claim 1 having a visible light transmittance higher than a visible light transmittance of the transparent base material.

19. An optical element comprising:
the optical film according to claim 1.

20. An optical system comprising:
a group lens including a plurality of lenses,
wherein a lens at an outermost surface of the group lens has the optical film according to claim 1.
